(19) United States
(12) Patent Application Publication
(10) Pub. No.: US 2016/0085296 A1
(43) Pub. Date: Mar. 24, 2016

(54) WEARABLE INPUT DEVICE

(71) Applicant: Intel Corporation, Santa Clara, CA (US)

(72) Inventors: Stanley Mo, Portland, OR (US); Joshua Ratcliff, San Jose, CA (US); Giuseppe Beppe Raffa, Portland, OR (US); Alexandra C. Zafiroglu, Portland, OR (US)

(21) Appl. No.: 14/494,388

(22) Filed: Sep. 23, 2014

(51) Int. Cl. G06F 3/01; G06T 19/00

(52) U.S. Cl. CPC G06F 3/011; G06F 3/017; G06T 19/003

(57) ABSTRACT

Various systems and methods for a wearable input device are described herein. A textile-based wearable system for providing user input to a device comprises a first sensor integrated into the textile-based wearable system, the first sensor to produce a first distortion value representing a distortion of the first sensor. The system also includes an interface module to detect the first distortion value, the distortion value measured with respect to an initial position, and transmit the first distortion value to the device, the device having a user interface, the user interface to be modified, responsive to receiving the first distortion value.

### TECHNICAL FIELD

Embodiments described herein generally relate to user-to-computer interfaces and in particular, to wearable input devices.

### BACKGROUND

As technology continues to permeate our everyday lives, interfaces to control computing resources have evolved to accommodate new uses, modes, and contexts. The miniaturization of electronic components is providing the ability to integrate computers, displays, and other informational devices into easy-to-access devices, such as watches, glasses, and other wearable technology.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a schematic drawing illustrating a textile-based wearable system, according to an embodiment;

FIG. 2 is a flowchart illustrating a method for providing user input to a device from a textile-based wearable system, according to an embodiment; and

FIG. 3 is a block diagram illustrating an example machine upon which any one or more of the techniques (e.g., methodologies) discussed herein may perform, according to an example embodiment.

### DETAILED DESCRIPTION

Conventional user input devices include such things as mice, keyboards, trackpads, and touchscreen displays. Some specialized input devices may be used in certain situations. For example, when interacting with three-dimensional (3D) objects in space, one may use spaceballs, special gloves, or camera-sensed gesture input. Such mechanisms may be awkward in certain contexts. For example, when riding a bus, a user with a glasses-based computing system may not want to use voice commands, large hand or body gestures, or a special input device (e.g., a spaceball or a spacemouse) to control the glasses-based computing system. What is needed is a user interface that provides an intuitive, simple, and discrete mechanism for user input.

While some wearable input devices exist, such as watches, they are limited in size and functionality. Clothing-based wearable input devices provide much more flexibility in input options and features. A long-sleeve shirt that includes embedded electronics or sensors may be worn under other clothing and be used as input to traditional or 3D platforms. Methodologies include, but are not limited to, changing the shape and physical characteristics of the fabric by moving a body part (e.g., rotating a wrist) or by manipulating the fabric (e.g., by pinching, pulling, or twisting the fabric). Additional embodiments are discussed below.

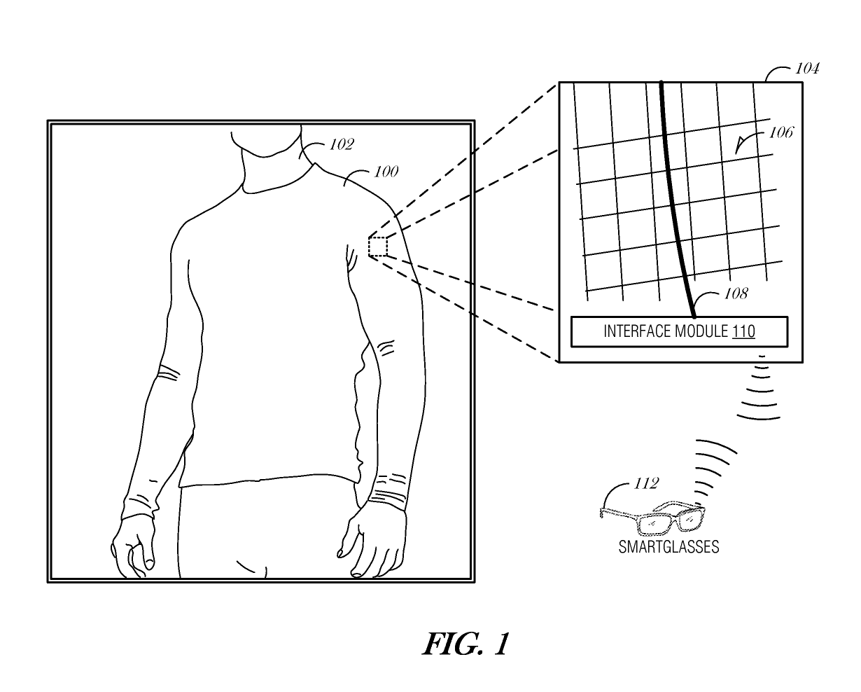

FIG. 1 is a schematic drawing illustrating a textile-based wearable system 100, according to an embodiment. FIG. 1 includes a user 102, who wears the textile-based wearable system 100. In the example shown, the textile-based wearable system 100 is a shirt. It is understood that other forms of textiles may be used including, but not limited to a scarf, a sleeve, a pant, a dress, a sock, an underwear item, a blanket, a tent, a bag, a hat, or any combination or portion thereof. For example, the textile-based wearable system may be in the form of a form-fitting, stretch fabric sleeve that is designed to be worn on one arm and cover the forearm from approximately the wrist region to an elbow region.

An exploded region 104 is shown to illustrate a magnified portion of the textile-based wearable system 100. The exploded region 104 includes the base fabric 106, which may be woven into a mesh in a conventional fashion, a sensor 108, and an interface module 110. The base fabric 106 may be any type of fabric, such as cotton, polyester, nylon, or other technical fabrics, such as GORE-TEX®. The sensor 108 may be any of various types of sensors, such as piezoelectric materials, bend fibers, flex sensors, or the like. The sensor 108 is used to sense distortion in the base fabric 106. While only one sensor 108 is shown in FIG. 1, it is understood that two or more sensors may be used to detect stretching, compression, or other deformation of the base fabric 106 in various dimensional planes.

The user 102 may actively manipulate the base fabric 106 or passively manipulate the base fabric 106. Active manipulation may be achieved by the user 102 pinching, squeezing, expanding, twisting, touching, or otherwise deforming or contacting the base fabric 106, such as with a finger, hand, palm, or other object. Passive manipulation may be achieved by simply moving the arm, leg, forearm, or any other portion of the body that covered by the base fabric 106. Movement may be detected by the deformations of the base fabric 106 to the sensor 108.

Active manipulations may be detected by sensing the tension in the sensor 108 as the arm (or other body part) moves. Such movement lengthens one sensor 108 and shortens another sensor placed in a different direction within the base fabric 106. By detecting these two forces (expansion and contraction), the sensors 108 may determine the degree of motion of the arm. So, rather than relying on an accelerometer, which doesn't measure distance, the mechanism uses the opposing extension and contraction of sensors 108 as a way to provide a more precise estimation of motion. Such a mechanism is also not subject to forces of acceleration from being in a moving vehicle or walking along the street. These forces may introduce error and may be mistaken for intentional motion. Additionally, a tension-based system may not have the power requirements and bulk of an accelerometer in clothing, making the overall appearance less intrusive, less power intensive, and more resistant to damage.

Another example of active manipulation is ad hoc manipulation of a stretchable fabric. For example, the user 102 may stretch a section of a sleeve in various directions or rotations, or push/pull it to provide input to a user interface. For example, rotating the fabric may rotate a user interface display, and pushing or pulling the fabric may perform movements in a 3D environment (e.g., pan or zoom). The interface module 110 may also be “programmed” to detect certain gestures, such as pinching the base fabric 106 or stretching it in a particular direction to initiate particular actions or macros in a user interface.

For passive manipulations, the interface module 110 may detect rotation of the arm as the sensors 108 stretch in response to arm twists. Laid out in a rectangular grid, detecting the distortion in the base fabric 106 allows determinations that the arm is rotating in a clockwise or counter-clockwise direction based on the direction of the distortion of the grid.

The interface module 110 is communicatively coupled to the sensor 108 and is configured to detect the deformations detected by the sensor 108. The interface module 110 may be wirelessly coupled to one or more sensors (e.g., sensor 108) to determine body movement or other manipulation of the base fabric 106 and the sensor 108. Alternatively, the interface module 110 may be wired directly to one or more sensors 108. Combinations of wired and wireless connections are also considered to be within the scope of the disclosure.

Using the sensor data from the sensor 108, the interface module 110 may communicate raw data or processed data to another device, such as smartglasses 112 worn by the user 102. The smartglasses 112 (or other device) may provide the user 102 a user interface. The sensor data may be used to affect the user interface, such as to control a pointer, select or activate objects, move through a 3D environment, or the like. While smartglasses 112 are illustrated in FIG. 1, it is understood that any computing device may be used, such as a mobile phone, table, hybrid computer, in-vehicle infotainment system, desktop computer, kiosk, automated teller machine, or other wearable devices (e.g., a watch), or the like.

In an example, the textile-based wearable system 100 includes the capabilities to act as a 3D input device. The sleeves of the shirt may be equipped with tension leads to detect motion at the wrist, elbow, and shoulder. By bending at these points, the user 102 may shift a cursor in Z-axis space by bending at the wrist, Y-axis space by bending at the elbow, and X-axis space by rotating at the shoulder. An advantage to this type of use is that the 3D input device capability is innocuous and may be used in relatively confined or awkward spaces. The technology may be built directly into clothing and may interact with 3D goggles or more conventional display panels (e.g., tablets, smartphones, kiosks, wall displays) via wireless or wired pathways. Such a mechanism is then always available to the user 102 and presents a consistent interaction model in their clothing for multiple devices, such as 3D glasses and a personal computer, for instance.

Using clothing deformation as an input mechanism allows user interaction regardless of the user's position. For example, whether the user's arm is straight at their side or bent at the elbow, the user 102 is able to discretely initiate inputs when standing or sitting. In this manner, the user 102 may interact with the system 100 while standing at a street corner in a crowd of people. For example, the user may hang their arm at their side and through subtle motions, direct cursors in their 3D glasses 112. Additionally, while sitting at a table, the user 102 may have their arm on top of the table and be able to initiate 3D inputs from this position. It simply requires that the input system measure the sensor stretch/stress to ascertain the “zero” point from which any additional deflection may be measured. So, with sensitive fiber stretch sensors, it is possible to detect very small amounts of movement where the user 102 may be in a tight space (like in a Japanese commuter train) simply by resetting the location of the arm and maximum amount of movement available. Zeroing the initial location of the sensor 108 may be performed by user input to the sensor 108, such as by double-tapping the sensor 108/base fabric 106. Other types of input may be used to set the initial position, such as with single-touch, multi-touch, or gesture input to the sensor 108/base fabric 106, observing sensor output to determine baseline positions, (e.g., differentiating between purposeful and incidental sensor readings via observation over time) or alternatively by controlling the sensor 108 with a secondary device, such as the smartglasses 112.

In some embodiments, electronic elastic fibers are integrated or woven into the base fabric 106, and the electrical characteristics are used to provide input to a device (e.g., a wearable device, a phone, etc.). The textile-based wearable system 100 may be local to a piece of base fabric 106 and multiple textile-based wearable systems 100 may be embedded in the clothing to provide multiple discrete input regions. The textile-based wearable system 100 may also enable setup of the particular movements and gestures, hence providing a level of personalization. Machine learning techniques for gesture recognition may be applicable in clothing-based gestures, where the features to the algorithm include the electrical characteristics (along their changes) of the base fabric 106/sensors 108.

Furthermore, the textile-based wearable system 100 enables users to train gestures (e.g., pinch, stretch, compress, swirl, twist, swipe, etc.) being performed on the garment. The textile-based wearable system 100 may accommodate for the specific characteristics of a particular fabric, such as elasticity, based on a training session. A machine learning algorithm, such as HMM for modeling time series, may take such sensor data as input and train specific models that map the gesture performed (e.g., pinch) and the characteristic of the fabric to a specific gesture.

In an embodiment, the textile-based wearable system 100 is composed of a distributed array of electronic elements, which allows a garment capabilities such as being able to be trained on recognizing specific motion patterns such as pinch, twist, stretch, and so forth. A communication system may be used to communicate sensor array data to a controller, which may be in the same garment or remotely located on or near the person. Typical sensor elements include piezoelectric or bend sensors.

In an embodiment, a textile-based wearable system 100 for providing user input to a device comprises a first sensor integrated into the textile-based wearable system 100, the first sensor to produce a first distortion value representing a distortion of the first sensor. The textile-based wearable system 100 also includes an interface module to: detect the first distortion value, the distortion value measured with respect to an initial position; and transmit the first distortion value to the device, the device having a user interface, the user interface to be modified, responsive to receiving the first distortion value.

In an embodiment, the textile-based wearable system further comprises a power supply. In a further embodiment, the power supply comprises one or more of a thermocouple-based power supply, a wireless power supply, or a piezoelectric power supply.

In an embodiment, the first sensor comprises a piezoelectric sensor. In another embodiment, the first sensor comprises a bend sensor. The first sensor may also be a flex sensor.

In an embodiment, the device comprises a mobile device. In a further embodiment, the mobile device comprises a wearable device.

In an embodiment, the device comprises an in-vehicle infotainment system. Using the system 100 may activate or control various functions of a vehicle, such as turning a volume up or down, changing radio channels, activating cruise control, raising or lowering the thermostat, or the like.

In an embodiment, the initial position is set by: receiving an initialization signal from a user; and setting the initial position based on the current position of the textile-based wearable system. The initialization signal may be a touch-based signal, such as a triple-tap of a sensor array, or a voice command, or some other input.

In an embodiment, the first sensor is woven into the textile-based wearable system 100. In an embodiment, the textile-based wearable system 100 comprises a shirt.

In an embodiment, the textile-based wearable system 100 also includes a second sensor integrated into the textile-based wearable system, the second sensor to produce a second distortion value representing a distortion of the second sensor. In this case, the interface module is to: detect the second distortion value; and transmit the second distortion value to the device, the device to modify the user interface using the first distortion value and the second distortion value.

In a further embodiment, the first and second distortion values indicate a pinching motion used on the textile-based wearable system 100. In a further embodiment, the user interface is modified by zooming out a portion of the user interface.

In a further embodiment, the first and second distortion values indicate a twisting motion used on the textile-based wearable system 100. In a further embodiment, the user interface is modified by rotating a portion of the user interface.

In a further embodiment, the first and second distortion values indicate a spreading motion used on the textile-based wearable system 100. In a further embodiment, the user interface is modified by zooming in a portion of the user interface.

In a further embodiment, the first and second distortion values indicate a double-tap on the textile-based wearable system 100. In a further embodiment, the user interface is modified by activating an object selected in the user interface.

In a further embodiment, the textile-based wearable system 100 includes a third sensor, the third sensor integrated into the textile-based wearable system, the third sensor to produce a third distortion value representing a distortion of the third sensor. In this case, the interface module is to: detect the third distortion value; and transmit the third distortion value to the device, the device to modify the user interface using the first, second, and third distortion values, where the first distortion value represents a first rotation of a first joint of a user's body, the second distortion value represents a second rotation value of a second joint of the user's body, and the third distortion value represents a third rotation of a third joint of the user's body, and where the user interface comprises a three-dimensional user interface with a camera view controlled by the first, second, and third distortion values.

In a further embodiment, the first distortion value represents a change in the x-plane in a three-dimensional space of the three-dimensional user interface, the second distortion value represents a change in the y-plane in the three-dimensional space, and the third distortion value represents a change in the z-plane in the three-dimensional space.

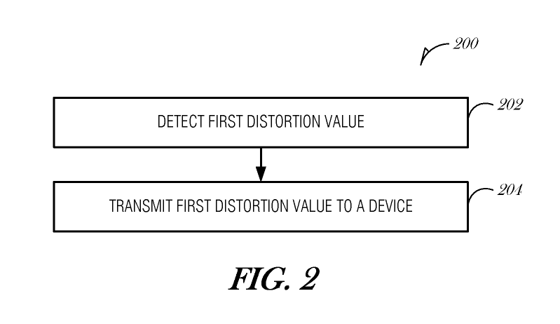

FIG. 2 is a flowchart illustrating a method 200 for providing user input to a device from a textile-based wearable system, according to an embodiment. At 202, a first distortion value of a first electronic fiber is detected, where the first electronic fiber integrated into the textile-based wearable system and the first distortion value measured with respect to an initial position.

In an embodiment, the initial position is set by: receiving an initialization signal from a user; and setting the initial position based on the current position of the textile-based wearable system.

In an embodiment, the first electronic fiber is woven into the textile-based wearable system. In a further embodiment, the textile-based wearable system comprises a shirt.

At 204, the first distortion value is transmitted to the device, where the device has a user interface, and the user interface to be modified, responsive to receiving the first distortion value. In various embodiments, the device comprises a mobile device, which may be a wearable device (e.g., glasses, watch, etc.), a relatively stationary device (e.g., a desktop, kiosk, wall display, etc.), or an in-vehicle infotainment system.

In a further embodiment, the method 200 includes detecting a second distortion value of a second electronic fiber, the second electronic fiber integrated into the textile-based wearable system; and transmitting the second distortion value to the device, the device to modify the user interface using the first distortion value and the second distortion value.

In an embodiment, the first and second distortion values indicate a pinching motion used on the textile-based wearable system. In a further embodiment, the user interface is modified by zooming out a portion of the user interface. For example, a user may be viewing a map in a heads up display in a vehicle, and to zoom out on a portion of the map, the user may pinch the textile-based wearable system. Similarly, the first and second distortion values may indicate a spreading motion used on the textile-based wearable system, in which case, the user interface is modified by zooming in a portion of the user interface (e.g., zooming in on a portion of the map).

In an embodiment, the first and second distortion values indicate a twisting motion used on the textile-based wearable system. In a further embodiment, the user interface is modified by rotating a portion of the user interface.

Although pinching, spreading, and twisting motions have been discussed, simple contact-based input may also be used. Contact-based input may be single tap, double tap, triple tap, or the like, and/or multi-finger or multi-contact input or gestures. Thus, in an embodiment, the first and second distortion values indicate a double-tap on the textile-based wearable system. In such an embodiment, the user interface may be modified by activating an object selected in the user interface.

In a further embodiment, the method 200 includes detecting a third distortion value of a third electronic fiber, the third electronic fiber integrated into the textile-based wearable system; and transmitting the third distortion value to the device, the device to modify the user interface using the first, second, and third distortion values, where the first distortion value represents a first rotation of a first joint of a user's body, the second distortion value represents a second rotation value of a second joint of the user's body, and the third distortion value represents a third rotation of a third joint of the user's body. For example, the user may articulate their shoulder, elbow, and wrist. The user interface may be a three-dimensional user interface with a camera view controlled by the first, second, and third distortion values. The first distortion value may represent a change in the x-plane in a three-dimensional space of the three-dimensional user interface, the second distortion value may represent a change in the y-plane in the three-dimensional space, and wherein the third distortion value may represents a change in the z-plane in the three-dimensional space. Using such a mechanism, the user may fly through or navigate 3D space using their arm movements.

While some embodiments have been described using a single sensor or a single textile-based wearable system, it is understood that multiple sensors or textile-based wearable systems may be used either as separate input mechanism, or as an integrated input mechanism. For example, to navigate 3D space, a user may map their right elbow to the x-plane, their right wrist to the y-plane, and their left wrist to the z-plane, such that to navigate through 3D space, the user uses both arms/wrists in tandem. Alternatively, the user may map one textile-based wearable system (or portion thereof) for one input (e.g., increasing or decreasing volume) and another textile-based wearable system (or portion thereof) for another input (e.g., changing radio stations). In such a configuration, the user may use their right wrist to control the volume and their left wrist for changing stations.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Examples, as described herein, may include, or may operate on, logic or a number of components, modules, or mechanisms. Modules may be hardware, software, or firmware communicatively coupled to one or more processors in order to carry out the operations described herein. Modules may hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

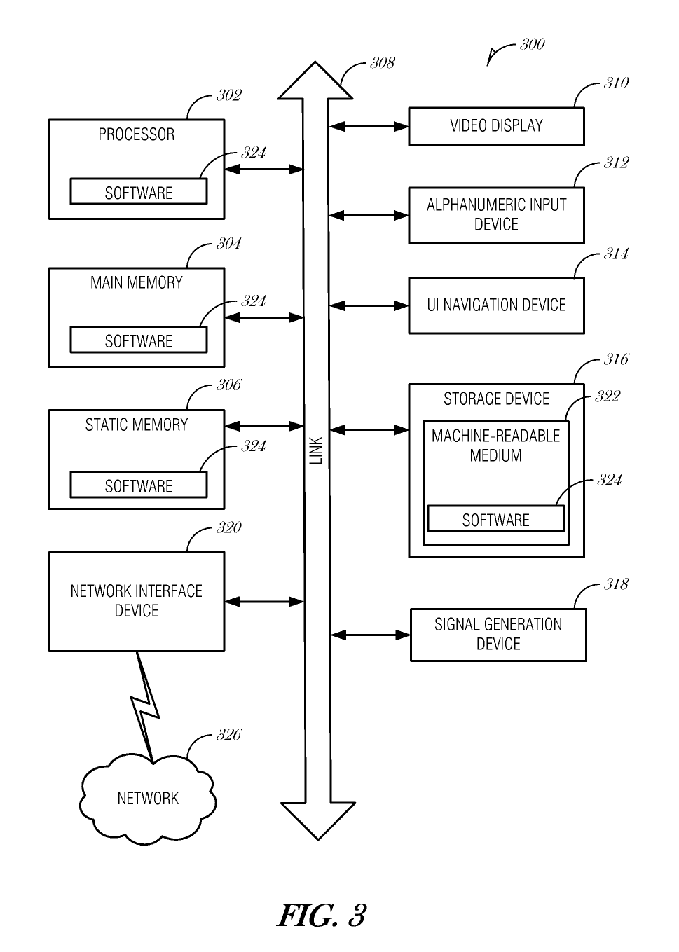

FIG. 3 is a block diagram illustrating a machine in the example form of a computer system 300, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 300 includes at least one processor 302 (e.g., a central processing unit (CPU), a graphics processing unit (GPU) or both, processor cores, compute nodes, etc.), a main memory 304 and a static memory 306, which communicate with each other via a link 308 (e.g., bus). The computer system 300 may further include a video display unit 310, an alphanumeric input device 312 (e.g., a keyboard), and a user interface (UI) navigation device 314 (e.g., a mouse). In one embodiment, the video display unit 310, input device 312 and UI navigation device 314 are incorporated into a touch screen display. The computer system 300 may additionally include a storage device 316 (e.g., a drive unit), a signal generation device 318 (e.g., a speaker), a network interface device 320, and one or more sensors (not shown), such as a global positioning system (GPS) sensor, compass, accelerometer, or other sensor.

The storage device 316 includes a machine-readable medium 322 on which is stored one or more sets of data structures and instructions 324 (e.g., software) embodying or utilized by any one or more of the methodologies or functions described herein. The instructions 324 may also reside, completely or at least partially, within the main memory 304, static memory 306, and/or within the processor 302 during execution thereof by the computer system 300, with the main memory 304, static memory 306, and the processor 302 also constituting machine-readable media.

While the machine-readable medium 322 is illustrated in an example embodiment to be a single medium, the term “machine-readable medium” may include a single medium or multiple media (e.g., a centralized or distributed database, and/or associated caches and servers) that store the one or more instructions 324. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 324 may further be transmitted or received over a communications network 326 using a transmission medium via the network interface device 320 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### Additional Notes & Examples

Example 1 includes subject matter for wearable input device (such as a device, apparatus, or machine) comprising: a textile-based wearable system for providing user input to a device, the textile-based wearable system comprising: a first sensor integrated into the textile-based wearable system, the first sensor to produce a first distortion value representing a distortion of the first sensor; and an interface module to: detect the first distortion value, the distortion value measured with respect to an initial position; and transmit the first distortion value to the device, the device having a user interface, the user interface modified by the first distortion value.

In Example 2, the subject matter of Example 1 may include, a power supply.

In Example 3, the subject matter of any one or more of Examples 1 to 2 may include, wherein the power supply comprises a thermocouple-based power supply.

In Example 4, the subject matter of any one or more of Examples 1 to 3 may include, wherein the power supply comprises a wireless power supply.

In Example 5, the subject matter of any one or more of Examples 1 to 4 may include, wherein the power supply comprises a piezoelectric power supply.

In Example 6, the subject matter of any one or more of Examples 1 to 5 may include, wherein the first sensor comprises a piezoelectric sensor.

In Example 7, the subject matter of any one or more of Examples 1 to 6 may include, wherein the first sensor comprises a bend sensor.

In Example 8, the subject matter of any one or more of Examples 1 to 7 may include, wherein the device comprises a mobile device.

In Example 9, the subject matter of any one or more of Examples 1 to 8 may include, wherein the mobile device comprises a wearable device.

In Example 10, the subject matter of any one or more of Examples 1 to 9 may include, wherein the device comprises an in-vehicle infotainment system.

In Example 11, the subject matter of any one or more of Examples 1 to 10 may include, wherein the initial position is set by: receiving an initialization signal from a user; and setting the initial position based on the current position of the textile-based wearable system.

In Example 12, the subject matter of any one or more of Examples 1 to 11 may include, wherein the first sensor is woven into the textile-based wearable system.

In Example 13, the subject matter of any one or more of Examples 1 to 12 may include, wherein the textile-based wearable system comprises a shirt.

In Example 14, the subject matter of any one or more of Examples 1 to 13 may include, a second sensor integrated into the textile-based wearable system, the second sensor to produce a second distortion value representing a distortion of the second sensor; wherein the interface module is to: detect the second distortion value; and transmit the second distortion value to the device, the device to modify the user interface using the first distortion value and the second distortion value.

In Example 15, the subject matter of any one or more of Examples 1 to 14 may include, wherein the first and second distortion values indicate a pinching motion used on the textile-based wearable system.

In Example 16, the subject matter of any one or more of Examples 1 to 15 may include, wherein the user interface is modified by zooming out a portion of the user interface.

In Example 17, the subject matter of any one or more of Examples 1 to 16 may include, wherein the first and second distortion values indicate a twisting motion used on the textile-based wearable system.

In Example 18, the subject matter of any one or more of Examples 1 to 17 may include, wherein the user interface is modified by rotating a portion of the user interface.

In Example 19, the subject matter of any one or more of Examples 1 to 18 may include, wherein the first and second distortion values indicate a spreading motion used on the textile-based wearable system.

In Example 20, the subject matter of any one or more of Examples 1 to 19 may include, wherein the user interface is modified by zooming in a portion of the user interface.

In Example 21, the subject matter of any one or more of Examples 1 to 20 may include, wherein the first and second distortion values indicate a double-tap on the textile-based wearable system.

In Example 22, the subject matter of any one or more of Examples 1 to 21 may include, wherein the user interface is modified by activating an object selected in the user interface.

In Example 23, the subject matter of any one or more of Examples 1 to 22 may include, a third sensor, the third sensor integrated into the textile-based wearable system, the third sensor to produce a third distortion value representing a distortion of the third sensor; wherein the interface module is to: detect the third distortion value; and transmit the third distortion value to the device, the device to modify the user interface using the first, second, and third distortion values, wherein the first distortion value represents a first rotation of a first joint of a user's body, wherein the second distortion value represents a second rotation value of a second joint of the user's body, and wherein the third distortion value represents a third rotation of a third joint of the user's body, and wherein the user interface comprises a three-dimensional user interface with a camera view controlled by the first, second, and third distortion values.

In Example 24, the subject matter of any one or more of Examples 1 to 23 may include, wherein the first distortion value represents a change in the x-plane in a three-dimensional space of the three-dimensional user interface, wherein the second distortion value represents a change in the y-plane in the three-dimensional space, and wherein the third distortion value represents a change in the z-plane in the three-dimensional space.

Example 25 includes subject matter for a wearable input device (such as a method, means for performing acts, machine readable medium including instructions that when performed by a machine cause the machine to performs acts, or an apparatus configured to perform) comprising a method of providing user input to a device from a textile-based wearable system, the method comprising: detecting a first distortion value of a first electronic fiber, the first electronic fiber integrated into the textile-based wearable system, the first distortion value measured with respect to an initial position; and transmitting the first distortion value to the device, the device having a user interface, the user interface to be modified, responsive to receiving the first distortion value.

In Example 26, the subject matter of Example 25 may include, wherein the device comprises a mobile device.

In Example 27, the subject matter of any one or more of Examples 25 to 26 may include, wherein the mobile device comprises a wearable device.

In Example 28, the subject matter of any one or more of Examples 25 to 27 may include, wherein the device comprises an in-vehicle infotainment system.

In Example 29, the subject matter of any one or more of Examples 25 to 28 may include, wherein the initial position is set by: receiving an initialization signal from a user; and setting the initial position based on the current position of the textile-based wearable system.

In Example 30, the subject matter of any one or more of Examples 25 to 29 may include, wherein the first electronic fiber is woven into the textile-based wearable system.

In Example 31, the subject matter of any one or more of Examples 25 to 30 may include, wherein the textile-based wearable system comprises a shirt.

In Example 32, the subject matter of any one or more of Examples 25 to 31 may include, detecting a second distortion value of a second electronic fiber, the second electronic fiber integrated into the textile-based wearable system; and transmitting the second distortion value to the device, the device to modify the user interface using the first distortion value and the second distortion value.

In Example 33, the subject matter of any one or more of Examples 25 to 32 may include, wherein the first and second distortion values indicate a pinching motion used on the textile-based wearable system.

In Example 34, the subject matter of any one or more of Examples 25 to 33 may include, wherein the user interface is modified by zooming out a portion of the user interface.

In Example 35, the subject matter of any one or more of Examples 25 to 34 may include, wherein the first and second distortion values indicate a twisting motion used on the textile-based wearable system.

In Example 36, the subject matter of any one or more of Examples 25 to 35 may include, wherein the user interface is modified by rotating a portion of the user interface.

In Example 37, the subject matter of any one or more of Examples 25 to 36 may include, wherein the first and second distortion values indicate a spreading motion used on the textile-based wearable system.

In Example 38, the subject matter of any one or more of Examples 25 to 37 may include, wherein the user interface is modified by zooming in a portion of the user interface.

In Example 39, the subject matter of any one or more of Examples 25 to 38 may include, wherein the first and second distortion values indicate a double-tap on the textile-based wearable system.

In Example 40, the subject matter of any one or more of Examples 25 to 39 may include, wherein the user interface is modified by activating an object selected in the user interface.

In Example 41, the subject matter of any one or more of Examples 25 to 40 may include, detecting a third distortion value of a third electronic fiber, the third electronic fiber integrated into the textile-based wearable system; and transmitting the third distortion value to the device, the device to modify the user interface using the first, second, and third distortion values, wherein the first distortion value represents a first rotation of a first joint of a user's body, wherein the second distortion value represents a second rotation value of a second joint of the user's body, and wherein the third distortion value represents a third rotation of a third joint of the user's body, and wherein the user interface comprises a three-dimensional user interface with a camera view controlled by the first, second, and third distortion values.

In Example 42, the subject matter of any one or more of Examples 25 to 41 may include, wherein the first distortion value represents a change in the x-plane in a three-dimensional space of the three-dimensional user interface, wherein the second distortion value represents a change in the y-plane in the three-dimensional space, and wherein the third distortion value represents a change in the z-plane in the three-dimensional space.

Example 43 includes at least one machine-readable medium including instructions, which when executed by a machine, cause the machine to perform operations of any of the methods of Examples 25-42.

Example 44 includes an apparatus comprising means for performing any of the methods of Examples 25-42.

Example 45 includes an apparatus for providing user input to a device from a textile-based wearable system, comprising: means for detecting a first distortion value of a first electronic fiber, the first electronic fiber integrated into the textile-based wearable system, the first distortion value measured with respect to an initial position; and means for transmitting the first distortion value to the device, the device having a user interface, the user interface to be modified, responsive to receiving the first distortion value.

In Example 46, the subject matter of Example 45 may include, wherein the device comprises a mobile device.

In Example 47, the subject matter of any one or more of Examples 45 to 46 may include, wherein the mobile device comprises a wearable device.

In Example 48, the subject matter of any one or more of Examples 45 to 47 may include, wherein the device comprises an in-vehicle infotainment system.

In Example 49, the subject matter of any one or more of Examples 45 to 48 may include, wherein the initial position is set by: receiving an initialization signal from a user; and setting the initial position based on the current position of the textile-based wearable system.

In Example 50, the subject matter of any one or more of Examples 45 to 49 may include, wherein the first electronic fiber is woven into the textile-based wearable system.

In Example 51, the subject matter of any one or more of Examples 45 to 50 may include, wherein the textile-based wearable system comprises a shirt.

In Example 52, the subject matter of any one or more of Examples 45 to 51 may include, means for detecting a second distortion value of a second electronic fiber, the second electronic fiber integrated into the textile-based wearable system; and means for transmitting the second distortion value to the device, the device to modify the user interface using the first distortion value and the second distortion value.

In Example 53, the subject matter of any one or more of Examples 45 to 52 may include, wherein the first and second distortion values indicate a pinching motion used on the textile-based wearable system.

In Example 54, the subject matter of any one or more of Examples 45 to 53 may include, wherein the user interface is modified by zooming out a portion of the user interface.

In Example 55, the subject matter of any one or more of Examples 45 to 54 may include, wherein the first and second distortion values indicate a twisting motion used on the textile-based wearable system.

In Example 56, the subject matter of any one or more of Examples 45 to 55 may include, wherein the user interface is modified by rotating a portion of the user interface.

In Example 57, the subject matter of any one or more of Examples 45 to 56 may include, wherein the first and second distortion values indicate a spreading motion used on the textile-based wearable system.

In Example 58, the subject matter of any one or more of Examples 45 to 57 may include, wherein the user interface is modified by zooming in a portion of the user interface.

In Example 59, the subject matter of any one or more of Examples 45 to 58 may include, wherein the first and second distortion values indicate a double-tap on the textile-based wearable system.

In Example 60, the subject matter of any one or more of Examples 45 to 59 may include, wherein the user interface is modified by activating an object selected in the user interface.

In Example 61, the subject matter of any one or more of Examples 45 to 60 may include, means for detecting a third distortion value of a third electronic fiber, the third electronic fiber integrated into the textile-based wearable system; and means for transmitting the third distortion value to the device, the device to modify the user interface using the first, second, and third distortion values, wherein the first distortion value represents a first rotation of a first joint of a user's body, wherein the second distortion value represents a second rotation value of a second joint of the user's body, and wherein the third distortion value represents a third rotation of a third joint of the user's body, and wherein the user interface comprises a three-dimensional user interface with a camera view controlled by the first, second, and third distortion values.

In Example 62, the subject matter of any one or more of Examples 45 to 61 may include, wherein the first distortion value represents a change in the x-plane in a three-dimensional space of the three-dimensional user interface, wherein the second distortion value represents a change in the y-plane in the three-dimensional space, and wherein the third distortion value represents a change in the z-plane in the three-dimensional space.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A textile-based wearable system for providing user input to a device, the textile-based wearable system comprising:
a first sensor integrated into the textile-based wearable system, the first sensor to produce a first distortion value representing a distortion of the first sensor; and
an interface module to:
detect the first distortion value, the distortion value measured with respect to an initial position; and
transmit the first distortion value to the device, the device having a user interface, the user interface to be modified, responsive to receiving the first distortion value.

2. The textile-based wearable system of claim 1, wherein the first sensor comprises a piezoelectric sensor.

3. The textile-based wearable system of claim 1, wherein the device comprises a mobile device.

4. The textile-based wearable system of claim 3, wherein the mobile device comprises a wearable device.

5. The textile-based wearable system of claim 1, wherein the initial position is set by:
receiving an initialization signal from a user; and
setting the initial position based on the current position of the textile-based wearable system.

6. The textile-based wearable system of claim 1, wherein the first sensor is woven into the textile-based wearable system.

7. The textile-based wearable system of claim 6, wherein the textile-based wearable system comprises a shirt.

8. The textile-based wearable system of claim 1, further comprising:
a second sensor integrated into the textile-based wearable system, the second sensor to produce a second distortion value representing a distortion of the second sensor;
wherein the interface module is to:
detect the second distortion value; and
transmit the second distortion value to the device, the device to modify the user interface using the first distortion value and the second distortion value.

9. The textile-based wearable system of claim 8, wherein the first and second distortion values indicate a pinching motion used on the textile-based wearable system.

10. The textile-based wearable system of claim 9, wherein the user interface is modified by zooming out a portion of the user interface.

11. The textile-based wearable system of claim 8, wherein the first and second distortion values indicate a twisting motion used on the textile-based wearable system.

12. The textile-based wearable system of claim 11, wherein the user interface is modified by rotating a portion of the user interface.

13. The textile-based wearable system of claim 8, wherein the first and second distortion values indicate a spreading motion used on the textile-based wearable system.

14. The textile-based wearable system of claim 13, wherein the user interface is modified by zooming in a portion of the user interface.

15. The textile-based wearable system of claim 8, wherein the first and second distortion values indicate a double-tap on the textile-based wearable system.

16. The textile-based wearable system of claim 15, wherein the user interface is modified by activating an object selected in the user interface.

17. The textile-based wearable system of claim 8, further comprising:
a third sensor, the third sensor integrated into the textile-based wearable system, the third sensor to produce a third distortion value representing a distortion of the third sensor;
wherein the interface module is to:
detect the third distortion value; and
transmit the third distortion value to the device, the device to modify the user interface using the first, second, and third distortion values,
wherein the first distortion value represents a first rotation of a first joint of a user's body, wherein the second distortion value represents a second rotation value of a second joint of the user's body, and wherein the third distortion value represents a third rotation of a third joint of the user's body, and
wherein the user interface comprises a three-dimensional user interface with a camera view controlled by the first, second, and third distortion values.

18. The system of claim 17, wherein the first distortion value represents a change in the x-plane in a three-dimensional space of the three-dimensional user interface, wherein the second distortion value represents a change in the y-plane in the three-dimensional space, and wherein the third distortion value represents a change in the z-plane in the three-dimensional space.

19. A method of providing user input to a device from a textile-based wearable system, the method comprising:
detecting a first distortion value of a first electronic fiber, the first electronic fiber integrated into the textile-based wearable system, the first distortion value measured with respect to an initial position; and
transmitting the first distortion value to the device, the device having a user interface, the user interface modified by the first distortion value.

20. The method of claim 19, wherein the initial position is set by:
receiving an initialization signal from a user; and
setting the initial position based on the current position of the textile-based wearable system.

21. A machine-readable medium including instructions for providing user input to a device from a textile-based wearable system, which when executed by a machine, cause the machine to perform operations comprising:
detecting a first distortion value of a first electronic fiber, the first electronic fiber integrated into the textile-based wearable system, the first distortion value measured with respect to an initial position; and
transmitting the first distortion value to the device, the device having a user interface, the user interface modified by the first distortion value.

22. The machine-readable medium of claim 21, wherein the initial position is set by:
receiving an initialization signal from a user; and
setting the initial position based on the current position of the textile-based wearable system.

23. The machine-readable medium of claim 21, wherein the first electronic fiber is woven into the textile-based wearable system.

24. The machine-readable medium of claim 21, further comprising:
detecting a second distortion value of a second electronic fiber, the second electronic fiber integrated into the textile-based wearable system; and
transmitting the second distortion value to the device, the device to modify the user interface using the first distortion value and the second distortion value.

25. The machine-readable medium of claim 24, further comprising:
detecting a third distortion value of a third electronic fiber, the third electronic fiber integrated into the textile-based wearable system; and
transmitting the third distortion value to the device, the device to modify the user interface using the first, second, and third distortion values,
wherein the first distortion value represents a first rotation of a first joint of a user's body, wherein the second distortion value represents a second rotation value of a second joint of the user's body, and wherein the third distortion value represents a third rotation of a third joint of the user's body, and
wherein the user interface comprises a three-dimensional user interface with a camera view controlled by the first, second, and third distortion values.
